(19) United States
(12) Patent Application Publication
(10) Pub. No.: US 2005/0249365 A1
(43) Pub. Date: Nov. 10, 2005

(54) Arithmetic operation method and apparatus for mixing audio signals

(76) Inventor: Jun Ishii, Hamamatsu-shi (JP)

Correspondence Address: HARNESS, DICKEY & PIERCE, P.L.C., P.O. BOX 828, BLOOMFIELD HILLS, MI, 48303, US

(21) Appl. No.: 11/124,569

(22) Filed: May 6, 2005

(30) Foreign Application Priority Data
May 7, 2004 (JP) 2004-138637

(51) Int. Cl. H04B 1/00; H04B 1/20

(52) U.S. Cl. 381/119; 369/4

(57) ABSTRACT

Mixer apparatus includes: a plurality of input channels and output channels; a signal processing device that sets a parameter for each of the plurality of input channels and/or output channels; and a signal processing device having a construction specialized in matrix operations. The signal processing device acquires a predetermined mixer conversion matrix corresponding to a combination of the respective numbers of input and output channels, calculates individual elements of the mixer conversion matrix on the basis of parameters set via the setting device, and performs a matrix operation of the mixer conversion matrix, using the individual calculated elements, in response to receipt of input signals for an input matrix.

### BACKGROUND OF THE INVENTION

The present invention relates generally to mixing arithmetic operation methods which use a digital signal processing device, such as a DSP (Digital Signal Processor), to mix input audio signals of a plurality of channels to thereby generate audio signals of the same number of channels as, or different number of channels from, the input audio signals. More particularly, the present invention relates to an improved audio-signal mixing arithmetic operation method which is suited to provide a digital audio mixer of a high operating speed and high versatility utilizing characteristics of an inexpensive and versatile DSP or the like.

In recent years, general-purpose DSPs have been significantly reduced in price, and more and more such DSPs have been introduced into consumer products. Audio mixers (mixing apparatus), which mix input audio signals of a plurality of channels to generate audio signals of the same number of channels as or different number of channels from the input audio signals, are no exception. Namely, in the field of audio mixers, there have been known digital audio mixers constructed with one or more general-purpose DSPs, as disclosed in Japanese Patent Application Laid-open Publication No. 2001-169400. In such digital audio mixers constructed with at least one general-purpose DSP, signal processing for mixing input digital audio signals of a plurality of channels is implemented by arithmetic operations performed by the DSP.

Generally, with the digital audio mixers, input digital audio signals have to be mixed and output in real time, and thus, there is a demand for the DSP to quickly carry out the arithmetic operations in order to minimize the processing time for the audio signal mixing. Therefore, as a way to minimize the quantity of mixing-related arithmetic operations to be performed by the DSP, some of the conventional digital audio mixers are arranged to sequentially carry out various arithmetic operations in accordance with the arrangements of audio channels implemented by the DSP (which include a user interface operable by the user for setting various mixing parameters, such as volume parameters). However, if such an approach of sequentially carrying out the various arithmetic operations in accordance with the arrangements of the audio channels is employed, there would be encountered a limit to the capability of reducing the processing time for the mixing-related arithmetic operations. Therefore, as one solution to such an inconvenience, it is conceivable to minimize the quantity of arithmetic operations by optimizing computational expressions corresponding to the audio channels so that the arithmetic operations optimal to the individual audio channels can be carried out. However, in such a case, there would arise a need to use a dedicated DSP that is designed to appropriately perform the arithmetic operation processing based on the optimized computational expressions corresponding to the arrangements of the individual audio channels. Consequently, if some change has been made to the functions of the audio channels implemented by the DSP, or if the dedicated DSP is used in another mixer having different audio channels, then the burden related to the arithmetic operation processing tends to unstable because the quantity of arithmetic operations increases or decreases, and the overall cost of the mixer tends to increase because the dedicated DSP is generally expensive.

Further, general-purpose DSPs, in general, include an arithmetic operation circuit specialized in matrix operations, and, in some cases, arithmetic operation processing based on general-purpose matrix operations can be performed at higher speed than the above-mentioned arithmetic operation processing (linear arithmetic operations) based on optimized computational expressions corresponding to the arrangements of the audio channels, although the former may involve a slight increase in the quantity of arithmetic operations. Therefore, it is conceivable to implement the mixing arithmetic operation processing on the basis of matrix operations using such a general-purpose DSP. However, the matrix operations generally involve an increased quantity of arithmetic operations; thus, if the mixing arithmetic operation processing is performed merely on the basis of matrix operations alone, the processing speed would be lowered rather than raised, so that there is presently a need for a technique for effectively avoiding the inconvenience. However, to date, there has been proposed no effective technique or method for implementing audio-signal mixing arithmetic operation processing based on matrix operations by a general-purpose DSP.

### SUMMARY OF THE INVENTION

In view of the foregoing, it is an object of the present invention to provide an audio-signal mixing arithmetic operation method and apparatus and program which can perform mixing arithmetic operation processing, using an arithmetic operation circuit provided in a general-purpose DSP and specialized in matrix operations, in order to realize a digital audio mixer of high operating speed and high versatility at low cost.

In order to accomplish the above-mentioned object, the present invention provides an improved arithmetic operation method for mixing a plurality of input signals to generate one or more output signals in a mixing apparatus including: a plurality of input channels and output channels; a setting device that sets a parameter for each of the plurality of input channels and/or output channels; and a signal processing device that has a construction specialized in a matrix operation. The arithmetic operation method comprises a step of acquiring a predetermined mixer conversion matrix corresponding to a combination of the respective numbers of input channels and output channels; a step of calculating individual elements of the mixer conversion matrix on the basis of the parameters set via the setting device; and a step of causing the signal processing device to perform a matrix operation of the mixer conversion matrix using the individual elements calculated by the step of calculating, in response to receipt of input signals corresponding to an input matrix.

In the present invention, the signal processing device, having a construction specialized in matrix operations, is caused to perform a matrix operation of a predetermined mixer conversion matrix, in response to receipt of input signals of individual input channels corresponding to input matrix and using individual elements calculated in accordance with set parameters. Thus, the input signals of the plurality of input channels are mixed to generate output signals of channels equal in number to the input channels or of one or more channels different in number from the input channels. As the mixer conversion matrix, there is acquired one that corresponds to a combination of the respective numbers of the input and output channels. Individual elements of the mixer conversion matrix are calculated on the basis of the parameters set via the setting device in corresponding relation to the plurality of input and/or output channels. In this manner, mixing arithmetic operation processing can be performed quickly, using, for example, an arithmetic operation circuit provided in the general-purpose signal processing device and specialized in matrix operations, with the result that a digital audio mixer of high operating speed and high versatility can be realized at low cost.

The present invention may be constructed and implemented not only as the method invention as discussed above but also as an apparatus invention. Also, the present invention may be arranged and implemented as a software program for execution by a processor such as a computer or DSP, as well as a storage medium storing such a software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1 is a block diagram showing a general hardware setup of an embodiment of a digital audio mixer to which is applied an audio-signal mixing arithmetic operation method in accordance with the present invention;

FIG. 2 is an audio channel diagram showing an example of various functions capable of being implemented by a DSP in the digital audio mixer of FIG. 1;

FIG. 3 is an audio channel diagram extractively showing only one of a plurality of input channels in the mixer of FIG. 2; and

FIGS. 4A and 4B are flow charts showing mixing procedures in mixing coefficient determination processing executed by the digital audio mixer that employs the audio-signal mixing arithmetic operation method of the present invention; more specifically, FIG. 4A shows an example of the mixing coefficient determination processing, while FIG. 4B shows an example of mixer processing.

### DETAILED DESCRIPTION OF THE INVENTION

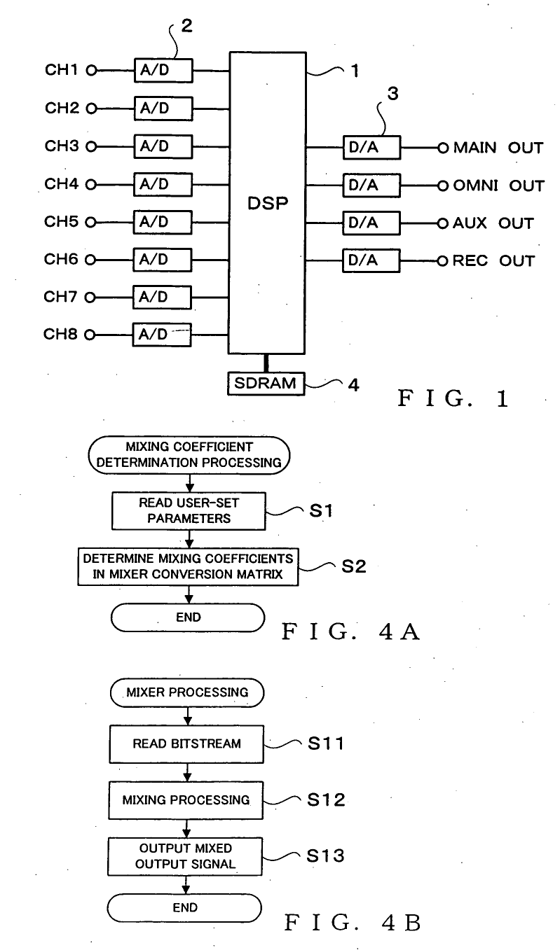

FIG. 1 is a block diagram showing a general hardware setup of an embodiment of a digital audio mixer to which is applied an audio-signal mixing arithmetic operation method in accordance with the present invention. In the illustrated example of FIG. 1, the digital audio mixer (hereinafter, also simply referred to as “mixer”) is arranged to mix analog or digital audio signals, input via eight input channels CH1-CH8, by means of a DSP 1 functioning as a signal processing means of the mixer, and then deliver the mixed signals to four output channels (MAIN OUT, OMNI OUT, AUX OUT and REC OUT). In the digital audio mixer of FIG. 1, it is the DSP 1 that performs mixing processing for mixing input audio signals of a plurality of channels to generate audio signals of the same number of channels as, or different number of channels from, the input audio signals. In the digital audio mixer of FIG. 1, the mixing processing, which is real-time processing to be performed in response to digital audio signals input in real time, is started up at a sampling frequency of, for example, 44.1 kHz based on operation of a single master clock (not shown) provided in the mixer, and the mixing processing completes the mixing of digital audio signals for one sample within one sampling period.

In FIG. 1, the input channels CH1-CH8 are channels for bitstream-inputting analog audio signals, supplied from an external input device (not shown) connected with the mixer, to the DSP 1. The input channels CH1-CH8 include respective A/D converters 2 for converting the input signals into digital audio signals if the input signals are in analog form. Needless to say, digital audio signals may be input directly (as-is) via the input channels CH1-CH8, in which case the A/D converters 2 are of course unnecessary. The directly-input or converted digital audio signals are supplied in parallel to the DSP 1 per sampling. The DSP 1 is a digital-signal processing general-purpose processor including an arithmetic operation circuit specialized in matrix operations. Microprograms for implementing the audio-signal mixing arithmetic operation method of the present invention are incorporated in the DSP 1, so that, in accordance with the microprograms, the DSP 1 performs digital signal processing, based on matrix operations, on the audio signals (audio stream) supplied from the input device and thereby generates mixed output signals. As will be later described in detail, the DSP 1 is caused to perform general-purpose matrix operations in which the mixing arithmetic operation processing is divided into real-time processing and non-real-time processing, and thus, the mixing arithmetic operation processing can be carried out at increased speed as compared to the case where linear operations are carried out by optimizing computational expressions corresponding to audio channels implemented by the DSP. Further, the DSP 1 also manages absolute times in the entire mixer.

After completion of the generation of the mixed output signals, the DSP 1 distributes the generated mixed output signals to the four output channels (MAIN OUT, OMNI OUT, AUX OUT and REC OUT), so that the mixed output signals are sent to an external output device connected with the mixer. The output channels include respective D/A converters 3 for converting the distributed mixed output signals into analog audio signals. The aforementioned operations to be performed by the DSP 1 are implemented by the microprograms (software) etc. executed within the DSP 1, and these microprograms are prestored in an SRAM 4 or the like connected to the DSP 1. To realize a long time delay, the SRAM 4 can also accumulate the stream-input digital audio signals.

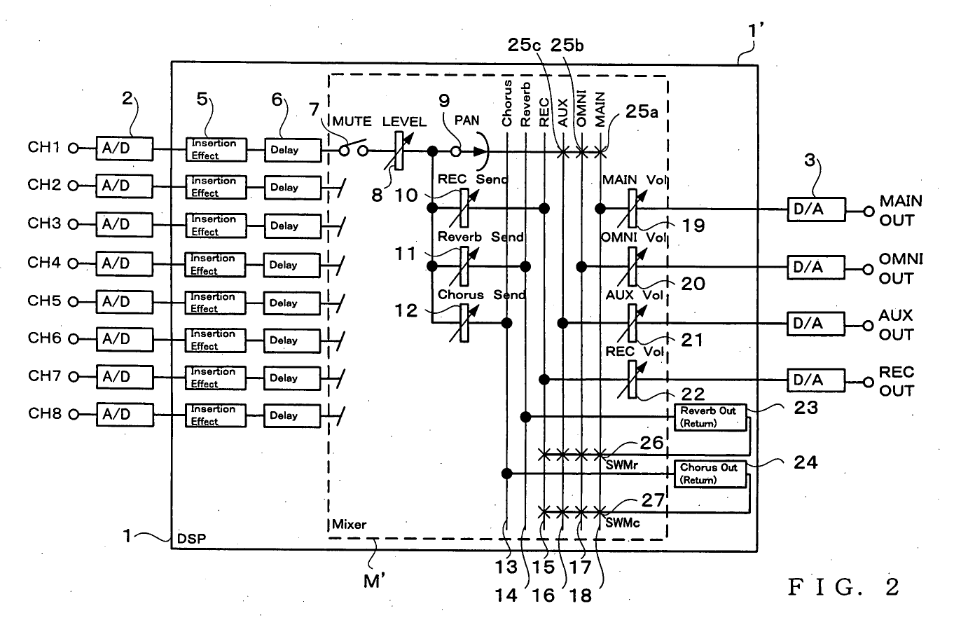

Next, with reference to FIG. 2, a description will be made about various functions that are implemented by the microprograms being executed within the DSP 1 in the digital audio mixer of FIG. 1. Namely, FIG. 2 is an audio channel diagram showing an example of the functions of the digital audio mixer which can be implemented within the DSP 1. In FIG. 2, the functions implemented by the microprograms within the DSP 1 are enclosed in a block 1′ indicated by dot-and-dash lines, and the other functions are implemented by other hardware than the DSP 1 actually provided in the body of the digital audio mixer. Further, a dotted-line block M′, contained in the dot-and-dash line block 1′ enclosing the functions implemented by the microprograms within the DSP 1, encloses the mixing functions for performing the mixing processing through the matrix operations. The matrix operations are real-time arithmetic operations carried out in response to digital audio signals input in real time.

First, a description will be given about the functions other than the functions enclosed in the dotted-line block M′ of FIG. 2. “Insertion Effect” sections 5, operating in correspondence with the input channels CH1-CH8, are each intended to selectively achieve one of various effects; that is, each of the “Insertion Effect” sections 5 imparts an effect to a digital audio signal input to the DSP 1. Examples of the various effects include “bypass”, “SMTPE decoder”, “analog MIDI decoder”, “Chorus/Reverb”, etc. “Delay” sections 6 following the “Insertion Effect” sections 5 are each intended to time-delay the corresponding input digital audio signal so as to supply the time-delayed signal as an input signal that is to be subjected to mixing by the mixer. The “Delay” section 6 of each of the input channels can operate independently of the “Delay” sections 6 of the other input channels. In each of the “Delay” sections 6, a desired delay time can be selected within a predetermined range of, for example, 0-1,000 ms (milliseconds).

Next, the mixing functions enclosed in the dotted-line block M′ in FIG. 2 are described. Various component parts (e.g., mute sections, volume controls, etc.) of the audio channels within the dotted-line block constitute a user interface operable by the user to set various mixing parameters. Note, however, that only one of the audio channels, corresponding to the input channel CH1, is representatively shown in FIG. 2; the other audio channels corresponding to the other channels CH2-CH8 can be shown in a similar manner to the one audio channel and hence are not specifically shown here. In FIG. 2, the audio channel is shown as having Chorus/Reverb functions as internal effector functions.

In the audio channel illustrated in FIG. 2, the total number of input channels is ten; that is, the input channels consist of the above-mentioned eight channels CH1-CH8, and a “Reverb Return” channel (23) and “Chorus Return” channel (24) for additively returning outputs of a “Reverb Out” channel 23 and “Chorus Out” channel 24 (which are both internal output channels) to main buses 15-18 among mix buses. On the other hand, the total number of output channels is six; that is, the output channels consist of the “MAIN OUT”, “OMNI OUT”, “AUX OUT” and “REC OUT” external output channels, and “Reverb Out” and “Chorus Out” internal output channels 23 and 24. Various signal-level adjusting parts or sections, such as the MUTE 7, LEVEL 8, PAN 9, REC SEND 10, REVERB SEND 11 and CHORUS 12, are provided in relation to the input channel CH1 that is, for example, in the form of a microphone/line-in input, by way of which the input channel CH1 is coupled to six mix buses, i.e. “Chorus” bus 13, “Reverb” bus 14, “REC” bus 15, “AUX” bus 16, “OMNI” bus 17 and “MAIN” bus 18. These six mix buses function as output channels via, or without requiring, respective volume controls, i.e., “MAIN Vol” 19, “OMNI Vol” 20, “AUX Vol” 21 and “REC Vol” 22. Thus, for input digital audio signals, the user can use such various parts to set a mute (MUTE 7), input level (LEVEL 8), left and right stereo pan values (PAN 9) and three send levels (REC Send 10, Reverb Send 11 and Chorus Send 12), as necessary. Further, for generated mixed signal, the user can set volumes, i.e. “MAIN Vol” 19, “OMNI Vol” 20, “AUX Vol” 21 and “REC Vol” 22, in correspondence with the external output channels (i.e., “MAIN OUT”, “OMNI OUT”, “AUX OUT and “REC OUT”), as necessary.

Although the mixing functions implemented by the DSP 1 constitute extremely complicated audio channels as illustrated in FIG. 2, the instant embodiment can express the mixing arithmetic operation processing in a matrix operation using a 6×10 matrix, despite the audio channel construction, in the case where ten input channels and six output channels are provided as note above. Thus, as the mixing arithmetic operation processing, the instant embodiment generates a 10th-order input vector on the basis of samples from the ten input channels and multiply the input vector i by a “6×10” mixer conversion matrix x prepared in advance, to thereby generate a sixth-order output vector o corresponding to the mixed output signals of the six output channels. Namely, the mixing arithmetic operation processing can be carried out by a matrix operation expression below.
o=x× (Mathematical Expression 1)

The input vector i in the matrix operation expression (Mathematical Expression 1) above expresses a total of input signals as a tenth-order input vector, using: eight sampling signals input via the eight input channels as “i₁”-“i₈”; a reverb return signal, returned from the “Reverb Out” internal output channel and then input as a signal of the “Reverb Return” input channel, as “Reverb”; and a chorus return signal, returned from the “Chorus Out” internal output channel and then input as a signal of the “Chorus Return” input channel as “Chorus”. As can be seen from FIG. 2, the “Chorus Out (Return)” 24 and “Reverb Out (Return)” 23 output channels at the last stage of the mixing function block are directed to other than the real-time processing, but, because processed results of these channels 24 and 23 are added to the main buses (“REC” bus 15, “AUX” bus 16, “OMNI” bus 17 and “MAIN” bus 18) among the mix buses, these inputs from the “Chorus Out (Return)” channel 24 and “Reverb Out (Return)” channel 23 too constitute the input vector i. The input vector i can be expressed by

$$i = [ \begin{matrix}{i}_{1} \\ {i}_{2} \\ {i}_{3} \\ {i}_{4} \\ {i}_{5} \\ {i}_{6} \\ {i}_{7} \\ {i}_{8} \\ Reverb \\ Chorus\end{matrix} ] \qquad ( Mathematical Expression 2 )$$

On the other hand, the output vector o in the matrix operation expression (Mathematical Expression 1) above expresses a total of six output signals as a sixth-order output vector, using: a mixed output signal from the “MAIN OUT” output channel as “o₁”; a mixed output signal from the “OMNI OUT” output channel as “o₂”; a mixed output signal from the “AUX OUT” output channel as “o₃”; a mixed output signal from the “REC OUT” output channel as “o₄”; a reverb output signal from the “Reverb OUT” output channel as “Reverb Out”; and a chorus output signal from the “Chorus OUT” output channel as “Chorus Out”. The output vector o can be expressed by

$$o = [ \begin{matrix}{o}_{1} \\ {o}_{2} \\ {o}_{3} \\ {o}_{4} \\ Reverb Out \\ Chorus Out\end{matrix} ] \qquad ( Mathematical Expression 3 )$$

The mixer conversion matrix x in the matrix operation expression (Mathematical Expression 1) above is a 6×10 matrix including, as its elements, mixing coefficients calculated in accordance with conversion matrixes to be later described (see Mathematical Expression 7—Mathematical Expression 15).

$$x = [ \begin{matrix}{x}_{11} & {x}_{12} & {x}_{13} & {x}_{14} & {x}_{15} & {x}_{16} & {x}_{17} & {x}_{18} & {x}_{19} & {x}_{110} \\ {x}_{21} & {x}_{22} & {x}_{23} & {x}_{24} & {x}_{25} & {x}_{26} & {x}_{27} & {x}_{28} & {x}_{29} & {x}_{210} \\ {x}_{31} & {x}_{32} & {x}_{33} & {x}_{34} & {x}_{35} & {x}_{36} & {x}_{37} & {x}_{38} & {x}_{39} & {x}_{310} \\ {x}_{41} & {x}_{42} & {x}_{43} & {x}_{44} & {x}_{45} & {x}_{46} & {x}_{47} & {x}_{48} & {x}_{49} & {x}_{410} \\ {x}_{51} & {x}_{52} & {x}_{53} & {x}_{54} & {x}_{55} & {x}_{56} & {x}_{57} & {x}_{58} & {x}_{59} & {x}_{510} \\ {x}_{61} & {x}_{62} & {x}_{63} & {x}_{64} & {x}_{65} & {x}_{66} & {x}_{67} & {x}_{68} & {x}_{69} & {x}_{610}\end{matrix} ] \qquad ( Mathematical Expression 4 )$$

In the mixing arithmetic operation processing indicated by Mathematical Expression 1 above, each of the elements xₙₘ is multiplied with one of the samples of digital audio signals of the input channels (input sampling signals). The thus-obtained product makes a mixed output signal (output sampling signal). Each of the elements xₙₘ is a mixing coefficient that differs in content depending on the structure of the user interface. In the mixing processing, the simple matrix operation expression (Mathematical Expression 1) is executed in real time in response to input or receipt of a sampling signal (“real-time” processing); however, operations concerning each element xₙₘ (mixing coefficient) in the mixer conversion matrix x indicated by Mathematical Expression 4 are executed as offline processing (i.e., “non-real-time” processing”) separately from the mixing matrix operations, each time the user interface is operated. Details of the element xₙₘ (mixing coefficient) in the mixer conversion matrix x will be explained later.

As the mixer conversion matrix x indicated by Mathematical Expression 4 above, one mixer conversion matrix is prepared in advance for each different combination of the respective numbers of the input channels and output channels, which has column-vs.-row relationship corresponding to the combination. For example, in the mixer where the number of the input channels is four and the number of the output channels is six, a “4×6” mixer conversion matrix x is prepared in advance which is expressed by

$$x = [ \begin{matrix}{x}_{11} & {x}_{12} & {x}_{13} & {x}_{14} & {x}_{15} & {x}_{16} \\ {x}_{21} & {x}_{22} & {x}_{23} & {x}_{24} & {x}_{25} & {x}_{26} \\ {x}_{31} & {x}_{32} & {x}_{33} & {x}_{34} & {x}_{35} & {x}_{36} \\ {x}_{41} & {x}_{42} & {x}_{43} & {x}_{44} & {x}_{45} & {x}_{46}\end{matrix} ] \qquad ( Mathematical Expression 5 )$$

Mixed output signals are generated by performing the matrix operation of Mathematical Expression 1 above using the 4×6 mixer conversion matrix x prepared in advance. Therefore, unless the combination of the numbers of the input channels and output channels is changed, mixed output signals can be generated by performing the matrix operation of Mathematical Expression 1 using the same mixer conversion matrix x.

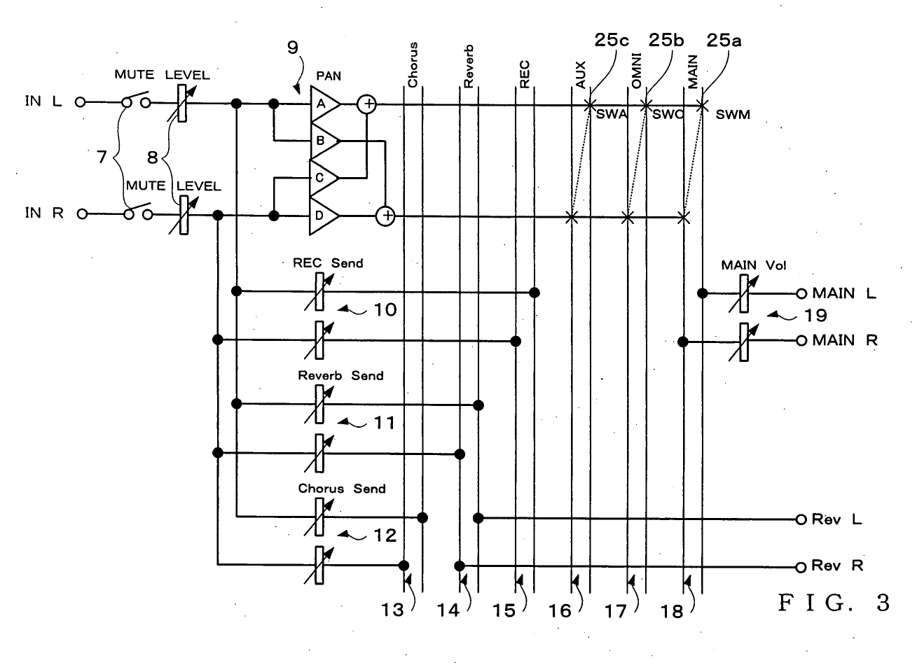

Now, a description will be given about the mixer conversion matrix x, with reference to FIG. 3. FIG. 3 is an audio channel diagram extractively showing only one of the input channels in the mixer of FIG. 2. What are indicated by monaural images in FIG. 2 are indicated by stereo images in FIG. 3. Namely, in the mixer shown in FIG. 3, the ten input channels and six output channels are each composed of left (L) and right (R) channels as stereo input and output channels. Further, in the mixer shown in FIG. 3, stereo signals are mixed by the “PAN” section 9. Specifically, the “PAN” section 9 includes four multipliers spanning, or working on, the L and R channels. Panning values that can be set by the “PAN” section 9 is in a range of −1 to +1. Coefficients A, B, C and D in the figure each vary as follows in accordance with the set panning value. Coefficient A takes a value “1” when the panning value is zero or over, but takes a value equal to (1+panning value) when the panning value is smaller than zero. Coefficient B takes a value “0” when the panning value is zero or over, but takes a value equal to (−panning value) when the panning value is smaller than zero. Coefficient C takes a value equal to the panning value when the panning value is zero or over, but takes “0” when the panning value is smaller than zero. Further, coefficient D takes a value equal to (1−panning value) when the panning value is zero or over, but takes “1” when the panning value is smaller than zero.

Where input-vs.-output relationship as shown in FIG. 3, i.e. stereo signals, is handled, a 2×2 matrix can be used to describe the input-vs.-output relationship. Therefore, for the mixer conversion matrix x of Mathematical Expression 4 applied to the mixer equipped with the audio channels as shown in FIG. 2, the 2×2 matrix may also be considered as a minimum unit in handling stereo signals. Namely, in this case, the mixer conversion matrix x can be expressed as a 12×20 matrix, where the inputs are indicated by the vertical columns while the outputs are indicated by the horizontal rows; further, a 2×2 matrix where a vertical column and horizontal row intersect indicates input-vs.-output relationship. More specifically, if an amount of mixing from the left (L) input to the left (L) output is given as “LL”, an amount of mixing from the right (R) input to the left (L) output is given as “RL”, an amount of mixing from the left (L) input to the right (R) output is given as “LR” and an amount of mixing from the right (R) input to the right (R) output is given as “RR”, the conversion matrix per minimum unit from the inputs (IN L and IN R) to the outputs (MAIN L and MAIN R, or Rev L and Rev R) can be expressed by

$$[ \begin{matrix}L & L & R & L \\ L & R & R & R\end{matrix} ] \qquad ( Mathematical Expression 6 )$$

However, for the outputs (Rev L and Rev R) that are not connected with the “PAN” section, RL=LR=0.

However, the minimum-unit conversion matrix indicated by Mathematical Expression 6 above differs in content depending on the arrangements of the audio channels. For example, the mixer having the audio channels as illustrated in FIG. 2 can be divided into: a first block including the “PAN” function or section 9 that performs ordinary input/output, such as “MAIN OUT”, “OMNI OUT” and “AUX OUT”; a second block that does not include the “PAN” section 9 and handles a recording input/output, such as “REC OUT”, with which the “REC Send” 10 and “REC Level” (not shown) are multiplied for both of the left and right channels; a third block that does not include the “PAN” section 9 and performs an input/output from/to any of the internal effectors, such as the “Reverb Out” output channel 23 or “Chorus Out” output channel 24 with which the “Reverb Send” 11 or “Chorus Send” 12 is multiplied for both of the left and right channels; and a fourth block that returns outputs of the individual internal effectors, such as the “Reverb Out” output channel 23 and “Chorus Out” output channel 24, to the buses, such as the “MAIN” bus 18, “OMNI” bus 17, “AUX” bus 16 and “REC” bus 15.

The conversion matrix of the first block in the mixer shown in FIG. 2 can be expressed by

$$\begin{matrix}\begin{matrix}\begin{matrix}{x}_{11} \sim {x}_{18} \\ {x}_{21} \sim {x}_{28}\end{matrix} \\ {x}_{31} \sim {x}_{38}\end{matrix} = [ \begin{matrix}L & L & R & L \\ L & R & R & R\end{matrix} ] & Mathematical Expression 7 \\ \begin{matrix} LL = MASTER \cdot SWMn \cdot A \cdot LEVELn \cdot MUTEn \\ RL = MASTER \cdot SWMn \cdot B \cdot LEVELn \cdot MUTEn \\ LR = MASTER \cdot SWMn \cdot C \cdot LEVELn \cdot MUTEn \\ RR = MASTER \cdot SWMn \cdot D \cdot LEVELn \cdot MUTEn\end{matrix} & Mathematical Expression 8\end{matrix}$$

Here, “MASTER” is a variable that takes an output volume value set by the “MAIN Vol” section 19, “SWMn” is a variable that takes a value “0” or “1” in accordance with switching setting by a “SWMn” 25a, and “A”-“D” are each a coefficient that takes a level value corresponding to a panning value set by the “PAN” section 9. Further, “LEVELn” is a variable that takes an input level value set by the “LEVEL” section 8, “MUTE” is a variable that takes a value “0” or “1” through switching by the “MUTE” 7 section, and “n” represents a unique channel number previously assigned to each input channel.

Mathematical Expression 8 concerns an output to the “MIAN OUT” channel. For the “OMNI OUT” or “AUX OUT” channel, SWMn in Mathematical Expression 8 is replaced with a variable SWOn that takes “0” or “1” in accordance with switching setting by the “SWMn” 25b or a variable SWAn that takes “0” or “1” in accordance with switching setting by a “SWAn” 25c, and MASTER is replaced with a variable OMNI LEVEL that is a volume value set by the “OMNI Vol” section 20 or a variable AUX LEVEL that is a volume value set by the “AUX Vol” 21.

The conversion matrix for the second block in the mixer shown in FIG. 2 can be expressed by

$$\begin{matrix}{x}_{41} \sim {x}_{48} = [ \begin{matrix}L & L & O & \\ O & & R & R\end{matrix} ] & Mathematical Expression 9 \\ \begin{matrix} LL = RecLevel \cdot ReSendn \cdot LEVELn \cdot MUTEn \\ RL = O \\ LR = O \\ RR = RecLevel \cdot RecSendn \cdot LEVELn \cdot MUTEn\end{matrix} & Mathematical Expression 10\end{matrix}$$

Here, “RecLevel” is a variable that takes an output volume value set by a recording level setting function (not shown), and “RecSendn” is a variable that takes an input volume value set by the “REC Send” section 10.

The conversion matrix for the third block in the mixer shown in FIG. 2 can be expressed by

$$\begin{matrix}\begin{matrix}{x}_{51} \sim {x}_{58} \\ {x}_{61} \sim {x}_{68}\end{matrix} = [ \begin{matrix}L & L & O & \\ O & & R & R\end{matrix} ] & Mathematical Expression 11 \\ \begin{matrix} LL = RevSendn \cdot LEVELn \cdot MUTEn \\ RL = O \\ LR = O \\ RR = RevSendn \cdot LEVELn \cdot MUTEn\end{matrix} & Mathematical Expression 12\end{matrix}$$

RevSendn is a variable that takes an input volume value set by the “Reverb Send” section 11.

Note that Mathematical Expression 12 above concerns output to the “Reverb OUT” channel. For output to the “Chorus OUT” channel, RevSendn in Mathematical Expression 12 is replaced with a variable ChorusSendn that takes an input level value set by the “Chorus Send” section 12.

Further, the conversion matrix for the fourth block in the mixer shown in FIG. 2 can be expressed by

$$\begin{matrix}\begin{matrix}{x}_{19} {x}_{110} \\ {x}_{29} {x}_{210} \\ {x}_{39} {x}_{310} \\ {x}_{49} {x}_{410}\end{matrix} = [ \begin{matrix}L & L & O & \\ O & & R & R\end{matrix} ] & Mathematical Expression 13 \\ \begin{matrix}{x}_{59} {x}_{510} \\ {x}_{69} {x}_{610}\end{matrix} = [ \begin{matrix}O & O \\ O & O\end{matrix} ] & Mathematical Expression 14 \\ \begin{matrix} LL = MASTER \cdot SWMr \\ RL = O \\ LR = O \\ RR = MASTER \cdot SWMr\end{matrix} & Mathematical Expression 15\end{matrix}$$

Here, SWMr is a variable that takes a value “0” or “1” through switching by a “SWMr” section 26, which indicates whether the “Reverb Return” channel is connected with the “MAIN” bus.

Note that Mathematical Expression 15 above concerns output from the “Reverb Return” channel to the “Main Out” channel. For output from the “Chorus Return” channel to the “MAIN OUT” channel, SWMr in Mathematical Expression 15 is replaced with a variable SWMc that takes a value “0” or “1” through switching by a “SWMc” section 27. Further, for output from the “Reverb Return” channel to the “OMNI OUT”, “AUX OUT” and “REC OUT” output channels, MASTER in Mathematical Expression 15 is replaced with a variable OMNI LEVEL that is a volume value set by the “OMNI Vol” section 20, a variable AUX LEVEL that is a volume value set by the “AUX Vol” section 21 and a variable REC LEVEL that is a volume value set by the “REC Vol” 22, respectively.

FIGS. 4A and 4B are flow charts showing mixing procedures executed by the digital audio mixer that employs the audio-signal mixing arithmetic operation method of the present invention. More specifically, FIG. 4A is a flow chart showing an example of “mixing coefficient determination processing” that is non-real-time processing, while FIG. 4B is a flow chart showing an example of “mixer processing” that is real-time processing. With reference to FIGS. 4A and 4B, a description will be given about the mixing processing where input audio signals of a plurality of channels are mixed to generate audio signals of channels equal in number to or different in number from the plurality of channels. The processing of FIGS. 4A and 4B are performed by the DSP 1.

At step S1 of the mixing coefficient determination processing of FIG. 4A, user-set parameters (mixing parameter data) set using the user interface are read. These user-set parameters are various mixing parameters set by the user using various parts (see FIG. 2), such as the mute and volume control sections implemented by the DSP 1, which include a volume value (MASTER) set via the “MAIN Vol” section 19, SWMn that takes “0” or “1” in accordance with switching setting by the “SWMn” section 25a, panning value set by the “PAN” section 9, input level value (LEVELn) set by the “LEVEL” section 8, MUTE that takes “0” or “1” in accordance with switching setting by the “MUTE” section 7, etc., as indicated, for example, by Mathematical Expression 8 above. At step S2, mixing coefficients of the mixer conversion matrix x are determined. Namely, individual coefficients of the mixer conversion matrix x (see Mathematical Expression 4) which correspond to the various user-set parameters read at step S1 are calculated on the basis of conversion matrixes (see Mathematical Expressions 7 and 8) prestored in correspondence with the audio channels.

The “mixer processing” shown in FIG. 4B is an interrupt process carried out per sampling period. At step S11, a bit stream per sampling is read for each of the input channels. At following step S12, the mixing processing is performed on the thus-read bit stream per sampling, to thereby generate a mixed output signal. In this mixing processing, as set forth above, the matrix operation indicated by Mathematical Expression 1 is carried out by the arithmetic operation circuit provided in the DSP and specialized in matrix operations. At next step S13, the thus-generated mixed output signal is delivered to any one of the output channels (MAIN OUT, OMNI OUT, AUX OUT and REC OUT), via which the mixed output signal is send to the external output device already connected with the mixer. This mixer processing is repetitively carried out as long as the bit stream reading continues.

When a change has been made to the user-set parameters set via the user interface, the “mixing coefficient determination processing” (non-real-time processing) is carried out to re-determine the individual mixing coefficients of the mixer conversion matrix x, irrespective of whether or not any bit stream has been read in the “mixer processing” (real-time processing). Then, the mixing processing is performed on a newly-read bit stream using the mixer conversion matrix x having the re-determined mixing coefficients reflected therein. In this manner, the user can change, as necessary, any of the mixing coefficients even during a performance (i.e., during real-time processing), so that the performance can be executed with the change reflected in the mixed output signals. In a case where the user-set parameters influence only a certain or ones of the mixing coefficients of the mixer conversion matrix x, only a relevant range of the mixing coefficients, which will be influenced, may be re-calculated, so that the necessary calculations can be advantageously carried out even more quickly.

With the above-described arrangements, the quantity of arithmetic operations to be performed can remain unchanged even when a change has been made to the audio channels, as long as the number of the input channels remain unchanged. Thus, it is possible to provide a highly-versatile digital audio mixer capable of generating mixed output signals at constant processing speed. Namely, when a change has been made to the audio channels, it is only necessary that the conversion matrix, i.e. the mixing coefficients in the conversion matrix x, be changed in accordance with the change to the audio channels; as a result, the instant embodiment of the present invention can achieve a greatly-enhanced versatility.

Further, in the instant embodiment, where the mixing arithmetic operation processing can be performed by the matrix operation, it is possible to employ a general-purpose DSP equipped with an arithmetic operation circuit specialized in matrix operations, so that a digital audio mixer of low cost can be provided.

Note that, whereas the embodiment has been described as employing a general-purpose DSP as signal processing means for executing the mixing arithmetic operation processing, the signal processing means may be implemented by any other suitable means as long as it is equipped with an arithmetic operation circuit specialized in matrix operations; for example, an inexpensive CPU, LSI, etc. may be employed as the signal processing means.

1. An arithmetic operation method for mixing a plurality of input signals to generate one or more output signals in a mixing apparatus including: a plurality of input channels and output channels; a setting device that sets a parameter for each of the plurality of input channels and/or output channels; and a signal processing device that has a construction specialized in a matrix operation, said arithmetic operation method:
a step of acquiring a predetermined mixer conversion matrix corresponding to a combination of respective numbers of input channels and output channels;
a step of calculating individual elements of the mixer conversion matrix on the basis of the parameters set via said setting device; and
a step of causing said signal processing device to perform a matrix operation of the mixer conversion matrix using the individual elements calculated by said step of calculating, in response to receipt of input signals corresponding to an input matrix.

2. An arithmetic operation method as claimed in claim 1 which further comprises a step of changing a computational expression for calculating the individual elements of the mixer conversion matrix in response to a functional change in said setting device, and
wherein, even when a functional change has been made to said setting device, a quantity of arithmetic operations to be performed by said signal processing device is not changed unless a change is made to the combination of the respective numbers of input channels and output channels.

3. An arithmetic operation method as claimed in claim 1 wherein said step of calculating individual elements of the mixer conversion matrix is performed by said signal processing device, and
said step of causing said signal processing device to perform a matrix operation of the mixer conversion matrix is performed in real time.

4. A microprogram for a signal processing device that has a construction specialized in a matrix operation, said signal processing device being used in a mixing apparatus including a plurality of input channels and output channels and a setting device that sets a parameter for each of the plurality of input channels and/or output channels, said microprogram being arranged to cause said signal processing device to perform an audio-signal mixing arithmetic procedure for mixing a plurality of input signals to generate one or more output signals, said audio-signal mixing arithmetic procedure comprising:
a step of acquiring a predetermined mixer conversion matrix corresponding to a combination of respective numbers of input channels and output channels;
a step of calculating individual elements of the mixer conversion matrix on the basis of parameters set via said setting device; and
a step of causing said signal processing device to perform a matrix operation of the mixer conversion matrix using the individual elements calculated by said step of calculating, in response to receipt of input signals corresponding to an input matrix.

5. A mixing apparatus comprising:
a plurality of input channels and output channels;
a signal processing device that sets a parameter for each of the plurality of input channels and/or output channels; and
a signal processing device that has a construction specialized in a matrix operation, said signal processing device performing:
a process for acquiring a predetermined mixer conversion matrix corresponding to a combination of respective numbers of input channels and output channels;
a process for calculating individual elements of the mixer conversion matrix on the basis of the parameters set via said setting device; and
a process for performing a matrix operation of the mixer conversion matrix using the individual elements calculated by said process for calculating, in response to receipt of input signals corresponding to an input matrix.
